(19) United States
(12) Patent Application Publication
(10) Pub. No.: US 2018/0236466 A1
(43) Pub. Date: Aug. 23, 2018

(54) SPRAY NOZZLE ARRANGEMENTS

(71) Applicant: LEAFGREEN LIMITED, STOURBRIDGE, WEST MIDLANDS (GB)

(72) Inventor: KEITH LAIDLER, WEST MIDLANDS (GB)

(21) Appl. No.: 15/751,942

(22) PCT Filed: Aug. 11, 2016
(86) PCT No.: PCT/GB2016/000148

§ 371 Date: Feb. 12, 2018

(30) Foreign Application Priority Data
Aug. 14, 2015 (GB) GB 1514468.6
May 11, 2016 (GB) GB1608242.2

(51) Int. Cl. B05B 1/34; B05B 1/08

(52) U.S. Cl. CPC B05B 1/3442; B05B 1/08

(57) ABSTRACT

A nozzle arrangement that produces an atomised spray or foam wherein the nozzle arrangement comprises a nozzle body with an inlet for a pressurized fluid into a chamber with an outlet orifice in the downstream wall and a prodder with a tapered conical tip wherein the prodder is inside of said chamber and at least part of the tip of the prodder protrudes inside the outlet orifice creating at least one circumferential gap between the prodder tip and the outlet orifice whereby the fluid spins around at least part of the prodder tip and out through the circumferential gap and produces an atomized spray or foam with a substantially full cone shape.

The present invention relates to a nozzle arrangement for delivering fluid from a nozzle as an atomized spray or foam by using a conically tapered insert in the final orifice forcing the fluid to exit the nozzle through a very narrow circumferential gap. The fluid enters into a chamber and then spins around the prodder in said chamber and then exits through a fine circumferential gap between the prodder tip and the outlet orifice. In a preferred version the prodder is able to slideably move within the outlet orifice and the movement is preferably but not exclusively restricted. The arrangement naturally produces a hollow cone but can be configured so that a substantially full cone spray or foam is produced.

Atomized sprays are usually created by spinning a fluid in a chamber and then through an outlet orifice and they usually generate a full cone spray although often there are less droplets in the centre area of the spray and sometimes hollow cones are produced. The fluid is spun in many different ways including simply entering the chamber tangentially and spinning around the chamber walls, or by entering into a swirl chamber just upstream of and around the spray orifice or putting an impeller inside the chamber that spins the fluid as it passes and other ways. As the fluid exits the orifice it spins and creates a cone and normally ambient air is sucked inside the centre of the spray orifice creating an air core like a whirl pool which helps with the atomization of the fluid and formation of the cone spray. Generally the smaller the orifice the finer the droplets but once the orifice becomes too small the air core cannot form and the fluid then often exits as a jet or as a poor spray. The cones tend to be either hollow or more usually less dense around the central area but the best designs have full and even cone sprays.

Often air is added to the liquor to enhance the atomization and generally to reduce the average droplet size. Usually high pressures are used plus high ratios of air to liquor and this is costly but the sprays produced are excellent.

Nozzle arrangements are used in many different fields of use and a great many different applications. Examples include agriculture, horticulture, industry, cooling, humidification, aerosol canisters, pumps, trigger sprayers, engines, ink jet printers and so on. In most cases the current technology produces the required performance and usually at very low cost and our innovation will be of limited value then. But for some applications it will be advantageous to use it and often it will be a simple matter of swapping our nozzles for those already in use. These include but aren't restricted to applications such as trigger sprayers, aerosol canisters especially those using compressed gas, misting nozzles for fine sprays, self cleaning nozzles where blockage or partial blockage can be a problem, self sealing nozzles to prevent drips or the fluid left inside the nozzle reacting with the air, applications where large droplets are unwanted, applications where very fine sprays are required and high pressures of fluid or air aren't available and so on.

Nozzle arrangements are used to facilitate the dispensing of various fluids from containers or vessels and this technology can be very useful in this field. For instance, nozzle arrangements are commonly fitted to pressurised fluid filled vessels or containers, such as a so called “aerosol canister”, to provide a means by which fluid stored in the vessel or container can be dispensed. A typical nozzle arrangement comprises an inlet through which fluid accesses the nozzle arrangement, an outlet through which the fluid is dispensed into the external environment, and an internal flow passageway through which fluid can flow from the inlet to the outlet. In addition, conventional nozzle arrangements comprise an actuator means, such as, for example, a manually operated aerosol canister. The operation of the actuator in the active phase means causes fluid to flow from the container to which the arrangement is attached into the inlet of the arrangement, where it flows along the fluid flow passageway to the outlet.

Manually actuated pump type fluid dispensers are commonly used to provide a means by which fluids can be dispensed from a non-pressurised container. Typically, dispensers of this kind have a pump arrangement that is located above the container when in use. The pump includes a pump chamber connected with the container by means of an inlet having an inlet valve and with a dispensing outlet via an outlet valve. To actuate the dispenser, a user manually applies a force to an actuator or trigger to reduce the volume of the pump chamber and pressurise the fluid inside. Once the pressure in the chamber reaches a pre-determined value, the outlet valve opens and the fluid is expelled through the outlet. When the user removes the actuating force, the volume of the chamber increases and the pressure in the chamber falls. This closes the outlet valve and draws a further charge of fluid up into the chamber through the inlet. A range of fluids can be dispensed this way this way including pastes, gels, liquid foams and liquids. In certain applications, the fluid is dispensed in the form of an atomised spray, in which case the outlet will comprise an atomising nozzle. The actuator may be push button or cap, though in some applications the actuator arrangement includes a trigger that can be pulled by a user's fingers.

A large number of commercial products are presented to consumers in both an aerosol canister and in a manual pump type dispenser, including, for example, antiperspirant, de-odorant, perfumes, air fresheners, antiseptics, paints, insecticides, polish, hair care products, pharmaceuticals, shaving gels and foams, water and lubricants.

There are numerous types of manually activated pumps and triggers and aerosol canisters on the market and they are sold in enormous volumes especially through the major retailers such as supermarkets. Consequently, they are very cheap and there is little profit in them for the manufacturers. Many of these and other applications would benefit from an improved performance using this innovation.

The technology is certainly not restricted to any of the applications already described and it can be used in a stand alone nozzle or as part of a system. It can be used with or without air or gas with one or more fluids.

This isn't simply a matter of using a tapered prodder in an orifice as that produces a hollow cone which has little value. The fluid has to be spun around the prodder which has to be substantially pointed or at least rounded and within a certain range of angles, lengths and diameters. The orifice is also preferentially shaped and the length, diameter and shape are critical for this to work well. It also works better if the prodder can move slideably inside the orifice and making it spring loaded gives the best results and this is preferably pretensioned. But if it can move too far then it is difficult to maintain a full cone in all the positions. In many applications the movement of the prodder has to be restricted to achieve the required performance or it moves too far upstream. At least part of the prodder tip has to be in the orifice during the spray cycle or a hollow cone is produced. The circumferential gap around the prodder has to be big enough to produce a full cone and not so big that an even more hollow cone is produced. Generally the larger the gap the more hollow the cone, the greater the flow and the larger the droplets.

The best performance with this technology is achieved when air or gas is added to the fluid which is usually a liquor either before, inside of or at the outside of the nozzle arrangement. As has been described, air is widely used with spray technology but usually you need large volumes and high pressures. Because we can create such a tiny circumferential gap superior atomization can be readily achieved with low volumes of gas or air and at low pressures.

This patent application is being split off from another sister patent application that we are doing simultaneously where the spray is pulsed and combining the pulsed action with this innovation creates many new opportunities for manipulation sprays. The pulse action can generate additional air or shock waves at the orifice or it can create an electrostatic charge in the fluid or it can create a sound wave at the orifice or it can affect the droplets as they pass through a closing circumferential gap and so on. Combining the pulsing action with this spray arrangement offers so many more opportunities. The pulsing action can be produced by the nozzle arrangement itself or it could be done with a pulsing mechanism upstream of the nozzle arrangement.

There are a number of different variations within this basic core configuration that can achieve different properties.

In a preferred arrangement the discharge is continuous.

In another preferred version the discharge is pulsed.

In another preferred version the fluid comprises one or more liquors.

In another preferred version the fluid is a liquor and one or more gases including air.

In another preferred version the nozzle arrangement is used as an actuator on an aerosol canister.

In another preferred version the nozzle arrangement is used as a nozzle on a dispenser pump that is actuated by a trigger or an actuator.

In another preferred version the nozzle arrangement is used as a misting nozzle for a variety of applications including cooling and watering.

In another preferred version the nozzle arrangement is used as an industrial nozzle.

In another preferred version the nozzle arrangement is used as a self cleaning nozzle.

In another preferred version the nozzle arrangement is used as a self sealing nozzle.

Other preferred applications include showerheads, horticulture, agriculture, engines and many more.

According to a first aspect of the present invention there is provided a nozzle arrangement that produces an atomised spray or foam wherein the nozzle arrangement comprises a nozzle body with an inlet for a pressurized fluid into a chamber with an outlet orifice in the downstream wall and a prodder with a substantially tapered conical or rounded tip inside of said chamber and at least part of the tip of the prodder protrudes inside the outlet orifice creating at least one circumferential gap between the prodder tip and the outlet orifice whereby the fluid spins around at least part of the prodder tip and out through the circumferential gap and produces an atomized spray or foam with a substantially full cone shape.

According to a second aspect of the present invention there is provided an arrangement as in the first aspect wherein some of the spray flows along the prodder tip protruding downstream of the circumferential gap to form an atomized spray with a substantially full cone shape.

According to a third aspect of the present invention there is provided a nozzle arrangement as in any of the preceding aspects wherein the prodder is spring loaded and slideably mounted and able to move inside the chamber and outlet orifice.

According to a fourth aspect of the present invention there is provided a nozzle arrangement as in any of the previous aspects wherein the circumferential gap is less than 5, 20, 50, 300, 500 microns.

According to an fifth aspect of the present invention there is provided a nozzle arrangement as in any of the preceding aspects wherein the resiliently deformable element or spring is pretensioned so the prodder cannot move from the rest position until the pressure of the fluid reaches a set pressure.

According to a sixth aspect of the present invention there is provided a nozzle arrangement as in any of the preceding aspects wherein part of the prodder tip is inside the final orifice during substantially all of the discharge cycle.

According to a seventh aspect of the present invention there is provided a nozzle arrangement as in the preceding aspects wherein the prodder can move to or through a position in the chamber that enables the nozzle arrangement to clear itself of any particulates in the orifice or around the prodder.

According to an eighth aspect of the present invention there is provided an arrangement as in any of the previous aspects wherein the travel of the prodder is restricted.

According to a ninth aspect of the present invention there is provided an arrangement as in any of the previous aspects wherein there is a prethrottle upstream of the prodder that helps to regulate the flow control.

According to a tenth aspect of the present invention there is provided an arrangement as in any of the preceding aspects wherein the circumferential gap varies according to the pressure or flow of the fluid.

According to an eleventh aspect of the present invention there is provided a nozzle arrangement as in any of the previous aspects wherein the fluid is pressurized by a dispenser pump that is manually actuated by a trigger or an actuator and the nozzle arrangement is attached to the outlet of the pump.

According to a twelfth aspect of the present invention there is provided a nozzle arrangement as in any of the previous aspects wherein the nozzle arrangement is attached to the outlet of a pressurized container including an aerosol canister.

According to a thirteenth aspect of the present invention there is provided a nozzle arrangement as in any of the previous aspects wherein at least part of the orifice is either substantially tubular or tapers conically outwards downstream or tapers conically inwards or is any combination of them.

According to a fourteenth aspect of the present invention there is provided a nozzle arrangement as in any of the previous aspects wherein the fluid flow through the nozzle arrangement is either pulsed or continuous.

According to a fifteenth aspect of the present invention there is provided a nozzle arrangement as in some of the other aspects wherein the prodder is fixed in place.

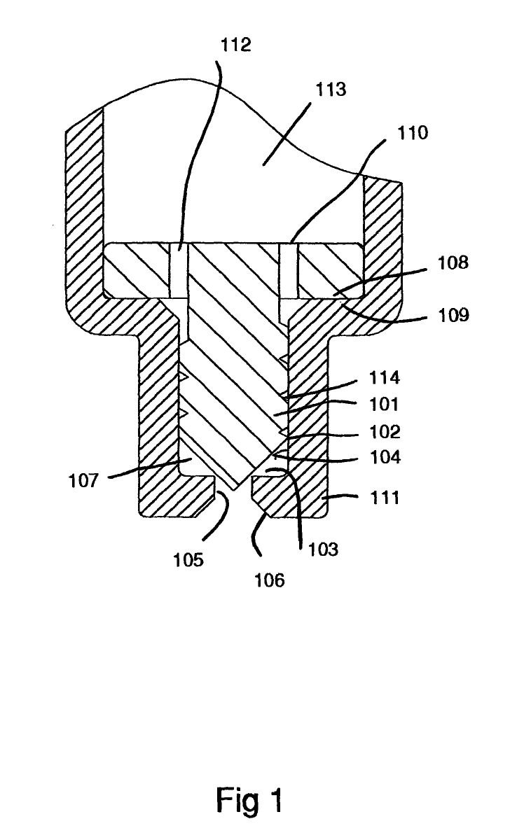

FIG. 1 is a cross-sectional view of a nozzle arrangement showing a preferred version wherein the prodder is fixed in position.

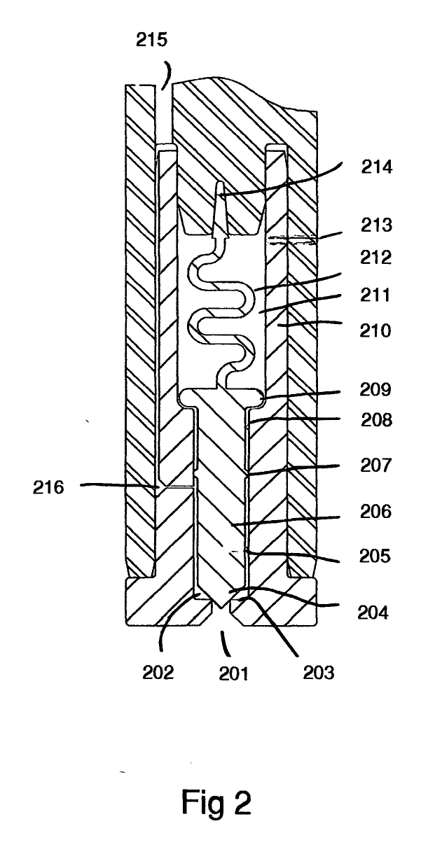

FIG. 2 is a cross-sectional view of a nozzle arrangement showing a preferred version where the prodder and plunger are one component and one fluid is delivered through a spray orifice.

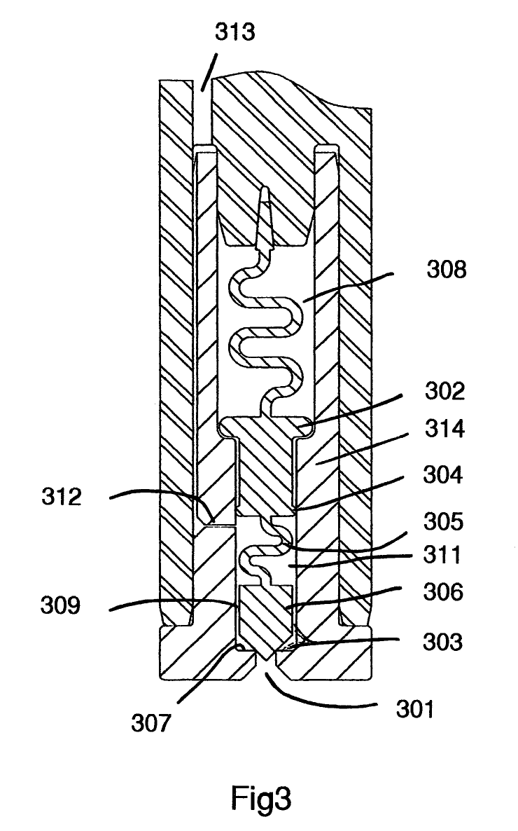

FIG. 3 is a cross-sectional view of a nozzle arrangement showing a preferred version where the pulsed element comprises one component and discharges one fluid through a spray orifice.

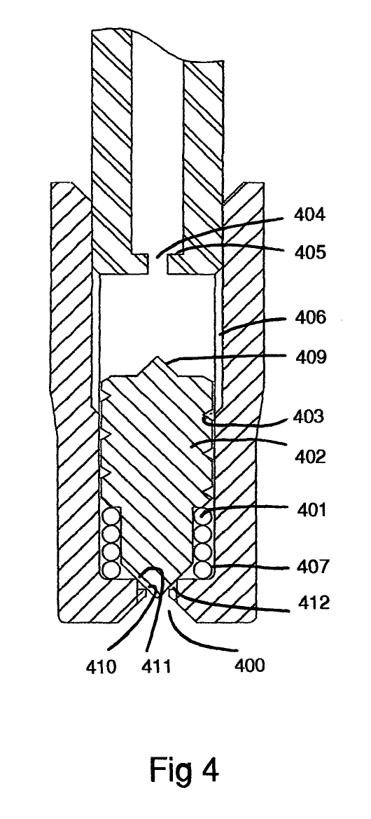

FIG. 4 is a cross-sectional view of a nozzle arrangement showing a preferred version where the pulsed element comprises one component and a spring and discharges one fluid through a spray orifice and is self cleaning.

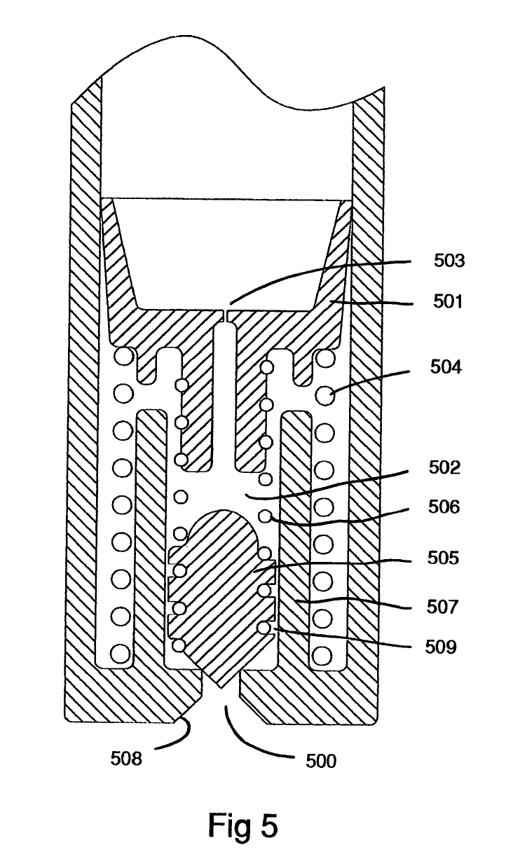

FIG. 5 is a cross-sectional view of a nozzle arrangement showing a preferred version where the pulsed element comprises two separate springs and pumps one fluid through a spray orifice and the main spring acts in an upstream direction.

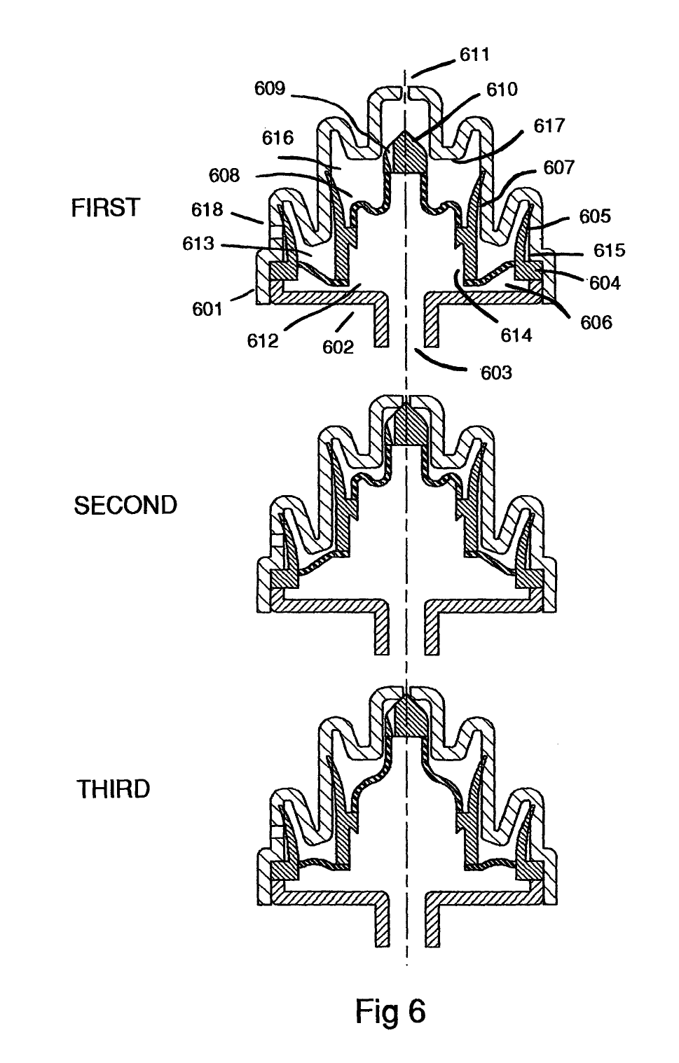

FIG. 6 is a cross-sectional view of a nozzle arrangement showing a preferred version where a second fluid is mixed with the first fluid inside the nozzle and then pumped out and 3 stages of the operation are shown.

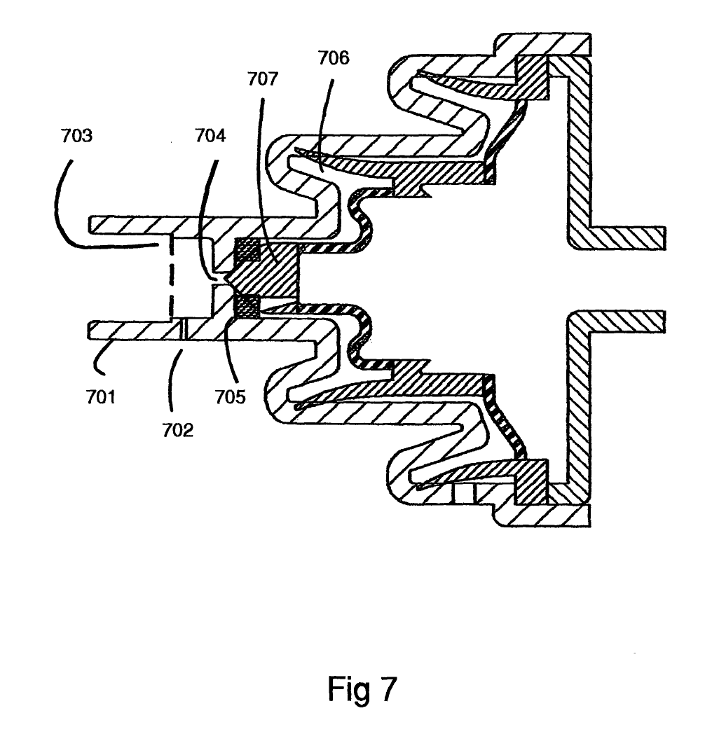

FIG. 7 is a cross-sectional view of a nozzle arrangement showing a preferred version where a second fluid is mixed with the first fluid for producing a foam with a mesh and a piece of foam in the nozzle body.

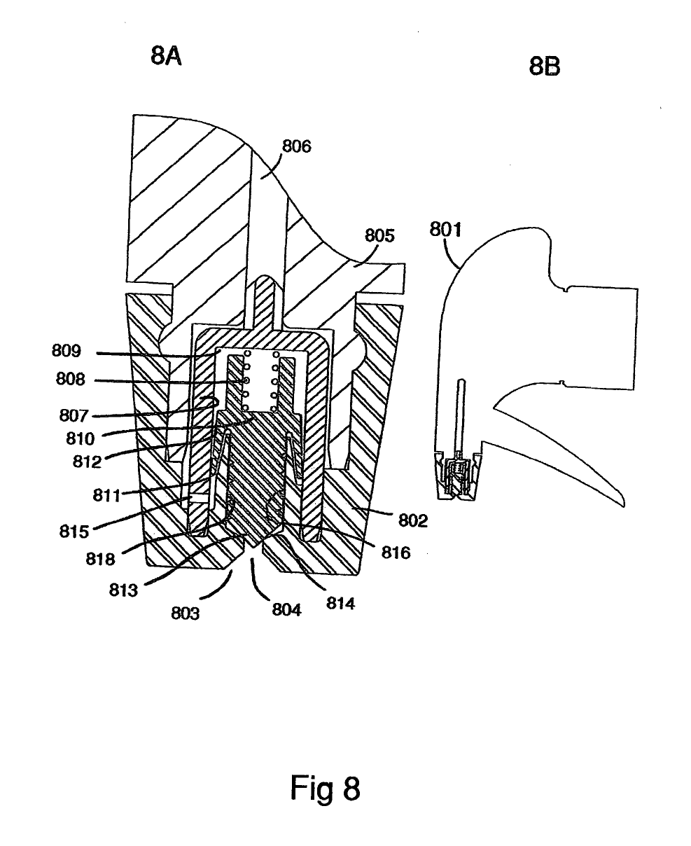

FIG. 8 is a cross-sectional view of a nozzle arrangement showing a preferred version where the nozzle is mounted onto the outlet of a trigger sprayer.

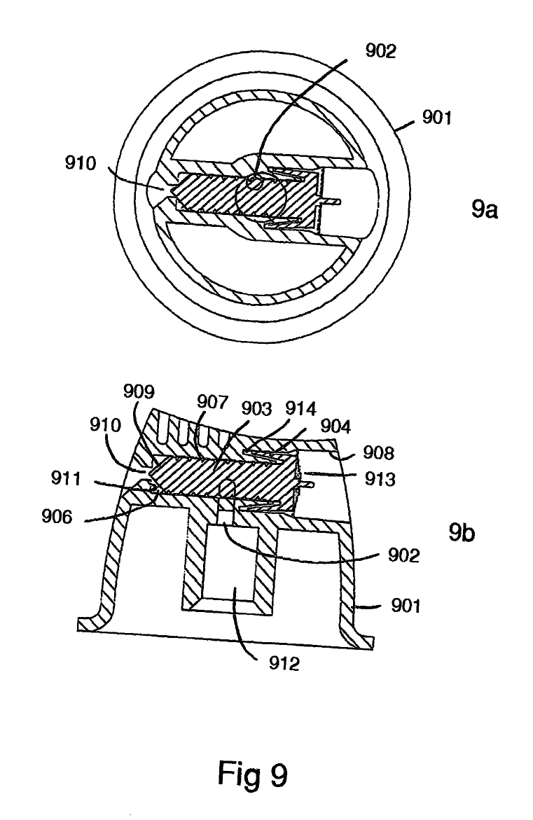

FIG. 9 is a cross-sectional view of a nozzle arrangement showing a preferred version where the nozzle arrangement is mounted in an aerosol actuator.

The atomized spray produced by the shaped prodder 101 in the shaped orifice can be generated as a continuous or pulsed spray by a range of different but similar configurations. The most basic configuration shown in FIG. 1 comprises a fixed prodder 101 with a threaded section 102 with circumferential grooves 114 that cause the fluid to flow around the prodder 101 through the grooves 114 and the threaded section 102 forms interference fit between the prodder 101 and the chamber wall 104. The prodder 101 cannot move and is positioned so that there is a fine circumferential gap 103 between the prodder 101 and the parallel sided tubular section 105 or upstream end of the outlet orifice. Downstream of this is in a preferable but not exclusive configuration is an outwardly tapered conical section 106 in the nozzle outlet orifice. The upstream prodder ledge 108 rests against an annular ledge 109 of the nozzle body 111 with holes 110 and 112 that allow the fluid to pass from the nozzle inlet chamber 113. The fluid flows around the circumferential grooves 114 in the prodder 101 wall and this causes the fluid to spin around the prodder 101 and out through the outlet orifice 106 as an atomized spray. As with all the configurations with the pointed tapered conical prodder 107, the outlet orifice cone 106 can determine the angle of the spray and the wider the cone angel the wider the spray angle until the angle is so wide that the fluid no longer fills the cone and it actually produces a narrower cone. Also, the wider the spray angle the less the throw, the less full the cone spray and the finer the droplets.

The objective of the innovation is too maintain a narrow circumferential gap 103 between the prodder 101 and the upstream outlet orifice 105, to cause the fluid to spin around the prodder 101 and then to produce an atomised spray after the circumferential gap 103. The gap downstream of the circumferential gap 103 is shaped to cause the spray to both spin outwards to create what would be a hollow cone and to spin inwards between and along the prodder point 107 and the upstream outlet orifice 105 creating a full cone inside the hollow cone. So the final spray is a substantially even and full cone. In addition everything has to be configured to create the spray cone angle that is required and the size of the droplets has to be optimized for each application. Some applications like misting nozzles, body spray aerosols and pumps require fine droplets with very few large droplets whilst other applications such as trigger sprayer cleaners, starch etc require large droplets with few fine droplets. Whilst there are a number of configurations that can create a full cone spray it is far more difficult to create all of the required parameters such as the droplet distribution for different spray applications.

The outlet orifice isn't always shaped as shown in FIG. 1 and sometimes there is no tapered conical downstream section 106, there may be a tapered conical section upstream of the orifice 105 with or without a tapered conical downstream section 106 upstream of the orifice. The orifice 105 itself may even have no tubular hole and could be a tapered conical section with or without tapered conical sections upstream or downstream of it. In most configurations where there is a conically tapered prodder tip 107 in the spray orifice 105 a substantially hollow cone with be produced and that is not acceptable. If the prodder tip 107 isn't substantially pointed then a poor spray is produced because the fluid flows up the prodder tip 107 and helps to fill in the centre of the spray cone. If the outlet orifice 105 is too large or the prodder 101 too narrow or too wide or too short then a hollow cone is produced. If there is no prethrottle controlling flow prior to the prodder 101 then the spray is often poor. If the prodder tip 107 is too far upstream to form a circumferential gap 103 then either a hollow cone is formed or the droplets are far too big or both.

An alternative version would be with the fluid entering the chamber tangentially like in FIG. 2 instead of from upstream and around the prodder 101 which could be smooth like the prodder 204 in FIG. 2 with a seal upstream of the fluid inlet such as in FIG. 2 with the seal 207. This would cause the fluid to spin around the prodder 101 to create the atomized spray so there would be no need for any circumferential groove. If the prodder tip 107 angle and length inside the orifice 105, the circumferential gap 103 between the prodder 101 and the orifice 105, the straight tubular section 105 of the nozzle orifice in length and diameter, the angle and length of the outlet cone 106, the spinning action of the fluid around the prodder 101, aren't fully optimised then the spray is very poor and usually produces a hollow cone and often produces big droplets or even jets. But if everything is fully optimized the spray is exceptionally good with fine, substantially evenly sized droplets and a full, even cone shape. The size of the circumferential gap 103 between the prodder 101 and orifice 105 is determined by the flow required with the lower the flow the smaller the gap but normally the gap is the equivalent of hole sizes that vary from 0.05-1 mm diameter and more usually 0.15-0.6 mm diameter. The orifice diameter used is normally but not exclusively between 0.3-2 mm and more usually 0.5-1.5 mm with the prodder diameter being very close to that of the orifice. So the circumferential gap 103 can be 0.3 mm down to as small as 0.005 mm and often smaller than 0.08 mm. This creates a manufacturing problem. The prodder 101 has to be substantially central inside the orifice 105 and such tolerances are extremely difficult to maintain for mass produced moulded products with very low prices. Also, the prodder tip 107 has to be placed very precisely inside the orifice 105 to produce a consistent gap that is often only just away from a sealing position and this is again extremely demanding with mass produced mouldings. Then even if the tolerances could be achieved, the parts will swell and shrink with different temperatures around the world and with different fluids. A prethrottle upstream of the prodder 101 is often used as a primary flow control but it isn't always desirable or practical. This is why the prodder 101 is often mobile and tensioned so that it can find the optimum position in the outlet hole 105. Again, a prethrottle is often used upstream of the prodder 101 or plunger and the inlet holes 112 and 110 could serve as prethrottles if required.

In most applications the discharge of the nozzle arrangement will be continuous but many applications will also use pulsed sprays. Some of the following figures will show pulsed discharges and others will show continuous discharges and some can be configured to do either. By no means are these meant to represent all of the possible applications of this technology as it can be used in all sorts of applications.

In FIG. 2 is shown a simple method of producing a configuration with a mobile prodder. The prodder spring 212 is shown as integral to the prodder 206 but it could also be a standard coiled metal spring or any other suitable resiliently deformable part instead. This doesn't produce a pulsed spray but rather produces a conventional continuous spray that is very even with fine droplets. But again only if all the parameters are optimized or the spray is poor. In practice, the prodder tip 204 seals the outlet 201 until the fluid reaches a set pressure which is dependant on the actuation force of the spring 212 acting between the prodder 206 and the upstream chamber wall 214, which is pretensioned in the rest position. This arrangement then acts as both a spray nozzle and a precompression valve and is useful for products like manually operated trigger sprayers and dispenser pumps and for none drip nozzles. The prodder 206 has a circumferential seal 207 that ensures that no fluid passes between the chamber wall 208 and the prodder 206 from or into the upstream chamber 211 with the spring 212. Usually but not exclusively there is a simple hole 213 that vents air to the atmosphere in the spring chamber wall 210. The fluid enters from upstream of the chamber wall at 215 and into the chamber 205 substantially tangential so it spins around the prodder 206 between it and the chamber wall 208. Varying this gap affects the rotation of the fluid around the prodder point 204 so it has to be optimized for different applications. Generally, it can be better than a standard swirl because it is much less prone to blocking. The size of the hole 216 into the chamber 205 can act as a prethrottle having a primary or secondary affect on the flow. As the prodder 206 moves upstream compressing the spring 212 the prodder point 204 immediately moves away from the sealing position and fluid passes it and exits out through the outlet hole 201 as an atomized spray. If the flow is very high then the prodder 206 moves further upstream and if it is very low it hardly moves at all although in reality the movement is tiny for all but the highest flows. Preferentially the prodder point 204 remains in the outlet hole 201 but in a none sealing position when operating and then into the full sealing position when deactivated. Similarly if the fluid pressure is high the main spring 212 is readily compressed and the prodder 206 moves further away from the hole 201 but if the flow is low then the movement is small. This applies if the spring 212 is strong or weak and the stronger the spring 212 the less the movement of the prodder 206 and vice versa. It is possible to make these self cleaning by occasionally increasing the usual operating flow or pressure so that the prodder 206 moves further upstream than normal and even away from the outlet hole 201. The position it moves to can be where the chamber 208 has a larger diameter just like as shown in FIG. 4 so there is a much bigger gap between the chamber wall 406 and the prodder 402 enabling anything trapped between the two parts to move downstream and through the fully open outlet hole 400. Similarly anything trapped between the prodder point 204 and the outlet hole 201 can also flow out. This would be as a crude spray, a jet or bolus of fluid but it would only need to be a momentary flow to clear everything.

In FIG. 3 we see a variant of FIG. 2 where there is an integral main spring 308 and there is a prodder spring 305. The fluid is sent under pressure from the input 313 through the channel 312 tangentially into the dosing chamber 311 and then between the prodder 306 and chamber wall 309. The tangential input 312 causes the fluid to spin in the chamber 311 and around the prodder 306 as it exits as an atomised spray. Normally but not necessarily, there is a resiliently deformable spring element 305 between the prodder 306 and plunger 302 as before so the plunger 302 moves upstream as the chamber 311 fills with the fluid until the prodder spring 305 is sufficiently tensioned and pulls out the prodder 306 and the fluid in the chamber 311 is discharged as the main spring 308 pushes the plunger 302 and prodder 306 downstream until the prodder 306 reseals in the outlet hole 301. The dosing chamber 311 then refills and the process continues causing the prodder 306 to create a pulsed spray. In practice the prodder 306 moves very small distances and the plunger 302 moves small to large distances largely depending upon the strength of the prodder spring 305. The pulses can be slow to fast according to the input flow and the size of the dosing chamber 311. In many applications the pulse is so fast that the discharge appears to be continuous. The main spring 308 and the prodder spring 305 may be integral to the plunger 302 or separate parts as required. Often, the pulsing element would be one part for cost and size and this is then exceptionally cheap which is ideal for aerosols, pumps and trigger sprayers as well as many other spray applications.

What is different between this and any ordinary pulsed nozzle arrangement is that the pulsed element is being used to generate and manipulate an atomised spray with movement of part of it in the spray orifice 301. In this case the movement is by the prodder 306 of the actual pulsing element but it could instead be a different part to the pulsing element and be moved by the pulsing action. It is also possible to follow the outlet 301 and prodder 306 combination with a second spinning arrangement such as a swirl chamber that takes the atomised spray from the prodder orifice and further refines the spray.

It offers an amazing number of possibilities for manipulating the spray. As already mentioned the fluid can spin around the prodder 306 as it enters into the outlet orifice 301. The prodder 306 tip can extend partially or wholly into that orifice 301 so it can either spin around the prodder 306 as it travels all the way through the orifice 301 or for part of the way through and then continue spinning in the remainder of the orifice 301. The spinning action can be generated by appropriately shaped grooves in the prodder 306 as seen in FIGS. 1 and 8, orifice 301, or wall 309 of the dose chamber 311 or any combination of them. Or it could be generated by suitably shaped fins around the prodder 306 body or between the prodder 306 and dosing chamber wall 309. Or the fluid could be directed so it enters the chamber 311 tangentially as here so it spins around the prodder which could then be smooth with no grooves or threads. The outlet orifice 301 can be shaped in any suitable way to enhance the manipulation of the spray.

Normally, the pulses will be short strokes of the prodder 306 with the none air versions so that they are fast. Air or gas could be added to the fluid itself such as in an aerosol canister for example with butane or CO2 as the propellant where some gas naturally exists in solution creating bubbles and more can be added through a bleed off in the aerosol valve called a vapour phase tap. It is this movement of the prodder 306 that offers so many new ways of manipulating the spray. With each pulse, the prodder 306 hits the orifice wall 307 and this can be used to set up a shock wave that further breaks up the droplets in the spray. This could be achieved by shaping the outlet 301 and adding a shaped chamber downstream of it. Similarly, a sound wave could be generated for the same purpose and generated by the prodder 306 striking the orifice wall 307. Or a component could be added downstream of the prodder 306 that is connected to it or just struck by it with each pulse and this could be made to vibrate by the prodder 306 movement and that vibration could cause a shock or sound wave to break up the droplets further. Or the spray could strike the vibrating part to cause or enhance atomisation. An open and shaped chamber could follow the orifice 301 to enhance these innovations.

With standard spray swirls, the smaller the orifice hole the finer the droplets but you can only mould hole sizes above a certain size in mass volumes because of the pins in the tools that make the holes, breaking. Typically the limit is around 0.18 mm diameter. With a prodder in the orifice the hole becomes the circumferential gap between the prodder and orifice and in practice it is difficult to make a small gap. But when the circumferential gap is created by the movement of the pulse and that movement can be made very small then so a very small circumferential gap is generated and this can be made to create a hollow cone spray that produces fine droplets. By shaping the prodder tip, the orifice or a chamber afterwards the hollow cone can be converted into a full cone again with fine droplets. The fluid is spun through the circumferential gap to create the atomization.

The prodder 306 can be shaped so that it rubs against the walls 307 and 309 of the inserted part 314 and by making said walls and the prodder 306 in the appropriate materials an electrostatic charge can be generated between the two parts so the fluid being discharged picks up the charge as it is sprayed charging the spray. This inserted part 314 also extends upstream of the plunger seal 304 and that also can increase the charge generated when the seal 304 rubs against it. Having two parts rubbing against each other at the orifice and generating a pulsed spray is an ideal combination for generating an electrostatically charged spray. The fact that the spray orifice is a very narrow circumferential gap also increases the charge because of the friction created by such a small gap. This would work with the air and none air versions and with the prodder 306 followed by a swirl and orifice or with the prodder in the orifice as described. When a swirl is used, the prodder 306 could rub against the part containing the post of the swirl instead of the inserted part 314.

The point of all of these examples is that the movement of the prodder in the spray orifice either directly or indirectly can be designed to be an active part of the spray manipulation. There will be other ideas than can be used with this pulsing element and these will doubtless be developed over time.

The nozzle arrangement in FIG. 3 can be configured to produce a continuous spray instead of a pulse spray. A simple way to do this is to increase the size of the inlet 312 relative to the size of the circumferential gap in the orifice 301 so that once the prodder 306 has pulled away from the sealing position, the flow of the fluid from the inlet 312 is so fast that the prodder can't return to the sealing position. The circumferential gap then becomes one that is big enough to accommodate the required flow.

The arrangements in FIGS. 2 and 3 show the main spring pushing the prodder downstream so that at rest the outlet orifice is sealed but in FIG. 4 the spring 401 pushes the prodder 402 upstream so in the rest position the outlet orifice 400 is unsealed. In this configuration the fluid initially drives the prodder 402 downstream to substantially the sealing position and compressing the spring 401 but as fluid passes the prodder 402 through the circumferential threaded groove 403 it then spins around the prodder 402 and spring 401 and equalizes the pressures up and downstream of the prodder so the spring 401 pushes the prodder 402 back upstream, allowing the fluid to be discharged through the outlet 400 as an atomized spray. When the discharge begins the upstream pressure on the prodder 402 reduces allowing the prodder 402 to move further downstream so the prodder tip is inside of the orifice 400 and forms a circumferential gap 410 that creates an atomized spray with a full cone. Varying the pressure and flow of the fluid plus the input hole 404 size relative to the outlet hole 400 and the spring strength determines the position of the prodder tip in the orifice 400 and the size of the circumferential gap 410. When the fluid flow is stopped the prodder 402 is pushed upstream by the spring 401 to where the upstream conical tip 409 seals the inlet hole 404 in the upstream wall 405 with the circumferential threaded groove 403 being opposite to the recess 406 in the chamber wall 407, enabling any blockage in the circumferential threaded groove 403 to fall out and this can be flushed downstream of the prodder 402 and out of the outlet orifice 400 the next time it the fluid is turned on. This figure also shows a second circumferential gap ledge 411 upstream of the final circumferential gap 410 and a small annular chamber 412 between them. The fluid passes through the upstream circumferential gap 411 and sprays into the tiny annular chamber 412, before leaving the downstream circumferential gap 410 as an atomized spray. This can help to produce finer droplets and can still form a full cone spray if everything is correctly configured. A venturi hole could be added to the annular chamber 412 so that air is sucked into the chamber as the fluid passes through and this can help to atomize the spray further. The hole could also be fed with pressurized air or gas instead. This arrangement could be used on any of the configurations and even 3 or more circumferential holes could be used.

If the fluid is turned on and off upstream of the nozzle arrangement then it naturally causes it to cycle and if it is turned on and off quickly then the nozzle becomes a pulsed nozzle. This can apply to any of the nozzle arrangements described provided that the prodder can move. But we would want these arrangements to retain the tip of the prodder in the orifice so a circumferential gap is created.

This arrangement effectively produces a self cleaning hollow or full cone spray nozzle that cleans away any particles that may partially or totally block the nozzle and has many applications throughout industry.

In FIG. 5 we see a similar configuration to FIG. 3 but using separate springs and like in FIG. 4 the prodder is in an unsealed position at rest. The fluid passes through the plunger 501 into the dosing chamber 502 through the hole 503 and the plunger spring 504 pushes the plunger 501 upstream. This means that in the rest or off position, the prodder 505 is away from the outlet hole 500 in a none sealing position and the plunger 501 is further upstream. In use, the fluid acts on the plunger 501 and pushes it downstream compressing the plunger spring 504 until the prodder 505 seals the outlet hole 500 and then compresses both springs 504 and 506 until the plunger 501 reaches its maximum downstream position. The fluid passes through the leak hole 503 in the plunger 501 and fills up the dosing chamber 502 which causes the plunger 501 to moves upstream and the prodder spring 506 to stretch. This process continues until the prodder spring 506 becomes tensioned enough to overcome the pressure of the fluid acting on the prodder 505 and the prodder 505 is pulled out of the outlet hole 500 allowing fluid to escape through said outlet hole 500. Once the prodder 505 is clear of the outlet hole 500 the prodder spring 506 returns to its none tensioned position further pulling the prodder 505 away from the outlet hole 500. But because the fluid is escaping through the outlet hole 500 the plunger 501 is also moving downstream pushing the prodder 505 towards the outlet hole until it seals there. Varying the leak rate through the inlet hole 503 in the plunger 501 determines the speed of the cycles as does the strength of the two springs and a pulse rate of anywhere from very slow to very fast to a continuous flow can be achieved. The stronger the prodder spring 506 the less distance the plunger 501 moves and the lower the dose per cycle and vice versa. It can also be configured so that the flow is continuous instead of pulsing and the prodder 505 can be made to move only a short distance away from the sealing position. This is mostly achieved by ensuring that the flow into the dose chamber 502 is higher than the flow out so the prodder 505 cannot return to the sealing position. By causing the fluid to rotate around prodder 505 usually with circumferential grooves either in or around the prodder 505 as shown or around the chamber wall 507, an atomised spray can be produced from the orifice 500. These grooves can also hold the prodder spring 506 as shown with groove 509 as there is still enough space for the fluid to flow in the grooves. But to achieve a fine and even spray the prodder 505 cannot come too far away and ideally it is very close to the sealing position so that a small circumferential gap is formed between it and the prodder 505 in the orifice 500. Also the orifice 500 preferentially but not exclusively has an outwardly tapered cone 508 at the downstream end. If the prodder 505 tip angle and length inside the orifice, the gap between the prodder 505 and the orifice, the straight tubular section of the nozzle orifice in length and diameter, the angle and length of the outlet cone, the spinning action of the fluid around the prodder 505, the distance the prodder 505 moves aren't fully optimized the spray is very poor with large droplets and a hollow cone spray shape but if everything is fully optimized the spray is exceptionally good with fine, substantially evenly sized droplets and a full, even cone shape.

In FIG. 6 first, second and third we see an example of a nozzle arrangement showing 3 of the stages of operation. For convenience, we will refer to the part that causes the pulsed sprays as the pulsed element 614 throughout the text and claims. This can be made as one part or in several parts depending upon the application and we see a one part version in FIG. 6. The fluid enters into the base 602 of the actuator or nozzle body 601 through the inlet tube 603 which could be connected to an aerosol canister valve, to the outlet from a pump dispenser actuated by an actuator or a trigger, or a flexible tube or to any outlet from a pressurized fluid source such as the mains water or a showerhead or even a car engine. The body 601 is usually made in an injection moulded plastic such as polypropylene, polyethylene, nylon, polyurethane etc but could be made in other materials like metals as well and it is normally but not exclusively, substantially rigid. It could be extended in length so that it fits directly onto a device rather than using a base plate 602 which would also normally be substantially rigid and made of the same material as the body 601.

The pulsed element 614 is inside the nozzle body 601 and in a preferred version it is made in one part which is a moulded component made of a suitable resiliently deformable material such as a rubber or any suitable plastic including but not restricted to polypropylene, polyethylene, polyurethane, etc. The upstream part of the pulsed element 614 has a resiliently deformable annular spring element 606 that also forms an annular seal 604, an annular sealing valve 605 and an inlet 603 for the fluid entering the nozzle body 601 so it can go through the pulsed element. The downstream part of the pulsed element 614 has an annular sealing valve 607, an outlet for the fluid 609, a prodder or shaped part 610 for sealing the outlet hole 611 of the nozzle body 601 and a resiliently deformable spring element 608. The pulsed element 614 divides the nozzle body 601 into a number of different chambers with a main upstream chamber 612 and a main downstream chamber 616 and two secondary annular chambers with one being a small secondary upstream chamber 615 and the other being a secondary downstream chamber 613.

Fluid flows into the main upstream chamber 612 and pushes the pulsed element 614 downstream from its position as shown in FIG. 1 first into its position shown in FIG. 6 second. The main spring element 606 on the upstream end of the pulsed element 614 is tensioned as the pulsed element moves down until it meets the shoulder 617 of the nozzle body 601. Any fluid in the lower secondary chamber 613 is pumped past the one way downstream annular seal 605 into the main downstream chamber 616 with the first fluid. The fluid in both secondary chambers is initially at ambient pressure. The prodder 610 seals the outlet hole 611 and the one way downstream annular seal 607 between the pulsed element 614 and the nozzle body 601 wall also seals any fluid in the downstream chamber 616. The fluid flows from the pulsed element 614 out into the main downstream chamber 616 through the leak hole 609. The fluid is pressurized and so it continues to flow into the main downstream chamber 616 until it is full and the pressure of the fluid acts upon the pulsed element 614 and moves the pulsed element 614 upstream because of the additional force of the main spring element 606. This action opens up the secondary downstream chamber 613 and the second fluid which is often air is drawn through the inlet hole 618 into the upstream secondary chamber 615 through the one way upstream annular seal 105 and into the secondary downstream chamber 613 and the fluid drawn in keeps the pressure in the secondary downstream chamber 613 at ambient pressure. As the pulsed element 614 moves upstream the spring element 608 of the prodder 610 expands and this process continues until the spring has reached its limit as shown in FIG. 6 third. At that point, the prodder 610 clears the outlet hole 611 and the prodder spring element 608 which is stretched as the pulsed element 614 moves upstream returns to its none tensioned position pulling the prodder 610 further away from the outlet hole. As soon as the prodder 610 clears the outlet hole 611, fluid starts to go through the outlet hole 611 and this causes a drop in pressure in the downstream main chamber 616 as the fluid in the upper chamber 612 cannot fill the lower main chamber 616 fast enough. Consequently, the pulsed element 614 moves back downstream forcing air out of the lower secondary chamber 613 past the annular valve 607 and into the downstream main chamber 616 where it mixes with the fluid and goes out of the outlet hole. The prodder 610 then reseals the outlet hole 611 and the pulsed element 614 continues to move down until it meets the shoulder 617 of the nozzle body 601. By then the main spring element 606 is tensioned again and the prodder spring element 608 isn't stretched. The lower main chamber 616 now contains some air and fluid mixed together and the air in the secondary downstream chamber 613 is substantially at ambient pressure. This process continues until the fluid in the nozzle is no longer pressurized and the pulsed element 614 moves upstream to the position shown in FIG. 6 first with both spring elements no longer tensioned. The fluid normally stays inside the nozzle arrangement because a shut off valve is usually upstream of the nozzle but if there isn't one; fluid could slowly drain from the nozzle through the pulsed element leak hole 609 and out of the outlet hole 611.

The speed of the pulsing is determined by the size of the leak hole 609, the pressure of the fluid, the strength of the main spring element 606, the size of the main downstream chamber 616 and the distance the spring element of the prodder 108 will allow the pulsed element 614 to move until the prodder 610 is pulled out of the hole 611. The discharge is determined by the size of the expanded main downstream chamber 616, the size of the secondary downstream air chamber 613 and the speed of return of the pulsed element 614, the pressure of the fluids. These things all have to be balanced to achieve the required performance.

The arrangement shown in FIG. 6 would normally produce a jet or bolus of fluid and often the outlet orifice would be followed by a swirl chamber and a further orifice and this would create an atomised spray. But there could also be a shaped orifice to produce a fan shaped spray or whatever is required. However, if the leak hole 609 is angled so that it enters the final chamber around the tip of the prodder 610 tangentially then it will spin inside that chamber and out through the final orifice 611 creating an atomized spray. This would produce a hollow cone which is unacceptable for most applications but if the prodder movement is restricted so that some of the prodder tip always stays inside the final orifice 611 and the diameter and length of the orifice 611 plus the prodder tip angle and usually the downstream shape of the orifice 611 is optimized then a substantially full cone spray can be achieved. There can be more than one tangential outlet 609 from the prodder 610 as well to improve the spinning action and the quality of the spray. The leak hole 609 could also be upstream of the prodder 601 so it enters tangentially into chamber 616 spinning around the pulse element and then the prodder 610. Even though the movement of the prodder 610 is then very small the plunger 614 can still be configured to have a relatively long movement so the discharge of fluids from the two chambers can be quite high or low as required.

If the final orifice 704 is followed by a tube 701 around the orifice 704 as shown in FIG. 7 then a foam will be produced. This foam can be enhanced with 1 or 2 filter meshes 703 in the tube 701 and this arrangement is common practice. However, it can be further refined using a piece of open cell foam 705 in the downstream main chamber 706 and this is partially or totally squashed when the prodder 707 seals in the outlet hole 704. There may then be no, one or more meshes in the tube 701 according to the requirements of the foam produced and the fluid used. Air is usually used as the second fluid. In FIG. 7 we see a venturi air inlet 702 in the tube 701 and this is commonly used with foams to draw more air into the fluid and could be used on any of the foam variants.

A version of this arrangement with no foam part 705 or mesh 703 could be used to generate an atomized spray with a full or hollow cone as before but with the added advantage of air to help atomize the fluid and sometimes a venturi to add more air to the spray. This is particularly helpful with atomizing viscose fluids such as oils. Separate springs or resiliently deformable parts could be used instead of the integral sprung parts of the pulse element.

In FIGS. 8A and 8B we see a simpler version of the pulse element like that of FIG. 3 where there is no second fluid and where the prodder outlet hole 804 is the spray orifice. The nozzle arrangement is shown mounted onto the outlet of a trigger activated manually operated dispenser but could just as easily have been mounted on a dispenser activated by an actuator or it could be mounted on or in any device where pressurized fluid is delivered and usually as an atomized spray. The nozzle 802 is fixed to the outlet 805 of the trigger sprayer and comprises a conically tapered outlet 803 and a substantially straight exit hole 804. A cover part 807 is fixed into the nozzle 802 and pushed inside the trigger sprayer outlet 806. The trigger outlet 806, the nozzle 802 and the cover part 807 are all sealably connected so that the fluid can only escape through the outlet orifice 804. The plunger and prodder are made in one 810 and have a circumferential seal 811 that seals between the prodder 810 and the cover part 807. A spring 808 that is around the upstream end of the prodder 810 and inside of the cover part 807 pushes the prodder 810 downstream causing the prodder tip to seal the outlet orifice 804 in the rest position.

As the trigger handle is pulled fluid is pumped through the channel 806 and around the cover part 807 through the hole 815 in the cover part 807 and into the chamber around the prodder 810. The fluid cannot flow upstream inside the cover part 807 because of the seal 811 so it flows around the prodder 810 towards the outlet orifice 804. The prodder 810 sits inside a tubular section 818 of the nozzle 802 and there are threads 816 around the prodder 810 that cause the fluid to flow around the prodder 810 and to spin around the conically tapered tip 813 of the prodder. Preferably there are 3 threads around the prodder 810 with 3 entry and exit points so the fluid spins evenly around the prodder 810. Once the pressure of the fluid around the prodder 810 has increased enough to overcome the force of the spring 808 which is pretensioned to a set force so the prodder 810 moves upstream unsealing the outlet orifice 804 and allowing the fluid to be discharged. The distance the prodder 810 moves upstream is determined by the strength of the spring 808, the pressure of the fluid, and the distance between the prodder 810 and the shoulder 809 on the cover part 807 which is designed to act as a back stop. The distance is also determined by the size of the orifice 804 since if it is very large then even a small upstream movement of the prodder 810 will result in a large gap and the prodder 810 may not move that far. As soon as the prodder 810 has unsealed the outlet orifice 804 the fluid will discharge and the flow will increase as the prodder 810 moves further away. Then as the pressure reduces so the prodder 810 will move back upstream under pressure from the spring until it finally reseals the outlet orifice 804.

A major problem with trigger actuated dispensers is the actuation force required and this is especially true with high discharges and is an enormous restriction of the volumes that can be discharged. The user pulls slowly and weakly at first and pulls progressively faster and harder as the stroke continues. With a standard fixed sized outlet orifice the discharge flow will increase as the pressure builds but a point is reached where the discharge hardly increases at all with the increasing pressure. This increases the fluid pressure as the fluid and consequently the user has to use even more force to pull the handle. So the peak force is really high and the user tends to reduce the actuation force and then stop pulling at this point often resulting in short pulls and reduced discharges. This all happens over around 0.6 seconds and the smaller the final orifice the greater the problem and the longer it takes to discharge plus the higher the actuation force needed. Yet the smaller the outlet orifice the finer the spray quality and the smaller the droplets and vice versa. With our technology, the circumferential gap increases with pressure so the harder the user pulls the handle, the faster the discharge yet the pressure remains fairly constant and as the circumferential gap is very small, fine droplets with no large droplets are produced. The travel of the prodder is restricted so that a full cone spray is always produced so there is a small increase in force needed at the end of the cycle but it is far lower than with a standard spray orifice. Also, as the user starts to reduce the force near to the end of the stroke the circumferential gap is reduced and this ensures that a high quality discharge is maintained throughout the discharge stroke and there are no large droplets produced. It also means that the discharge takes less than 0.1 seconds and usually around 10-15% of the time needed with a standard trigger. As the effort expended by the user is determined by the force and the time then clearly it is considerably less with our system. This means that larger volumes of fluid can be pumped and that means that the user needs to do fewer discharges. This also applies to dispenser pumps that are actuated by an actuator. Using a variable sized but limited final orifice size throughout the discharge offers many benefits and will be claimed for.

To make this arrangement pulse the prodder 810 has to be made resiliently deformable either by just the material or by that and shaping the prodder 810 itself including an integral spring shape. So, when the prodder 810 first moves upstream the prodder 810 stretches or reforms and the prodder 810 stays sealed in the outlet orifice 804 until it is easier for the prodder 810 to move into an unsealing position rather than stretch or reform anymore. So the prodder 810 acts as a spring and a more obvious example is shown in FIG. 3 where an integral shaped spring 305 is created. Once it reaches an unsealed position the fluid will quickly discharge and provided the discharge is faster than the fluid can enter into the chamber around the prodder 810, the prodder 810 will return to the sealed position. This process continues until most of the fluid is discharged and produces a pulsed spray. It is possible to make it pulse even with a substantially rigid prodder 810 but it is difficult to balance everything.

If the prodder tip 813 moves completely out of the outlet orifice 804 then a substantially hollow cone or an almost full cone and both with large droplets is produced and this is not desirable. But if the prodder tip 813 is always kept partially inside the outlet orifice 804 then fine droplets can be produced. Even then the spray produced is substantially a hollow cone which is still not desirable. This problem can be reduced by shaping the outlet orifice upstream wall 903 such as making it conical as shown as this effectively extends the length of the outlet orifice 901 enabling the prodder to move further upstream. It also impacts on the angle and form of the final spray. But as shown in other figures this wall could also be perpendicular to the chamber and that will be better for some nozzle arrangements used on triggers. But the angle, diameter and length of the prodder tip 813, the diameter and length of the outlet orifice 804, the shape of the outlet orifice upstream wall 903 and the shape of the outlet orifice 804, the position of the prodder tip in the orifice can be optimized in such a way that a substantially full cone with fine droplets can be produced. Most configurations naturally produce a hollow cone so the optimization of the configurations is really essential. It is important both for a pulsed spray and as a continuous spray.

As the prodder 810 moves upstream the air inside the cover part 807 that is upstream of the seal 811 is compressed and then returns to ambient pressure as the prodder returns to the sealing position. Since the movement is so small the change in air pressure isn't great so it isn't a problem. But it would be easy enough to design in an air release valve system in that chamber that lets air in as the prodder 810 moves downstream and lets air out as said prodder moves upstream if it was a problem.

This nozzle arrangement has been configured to retrofit to current triggers actuated dispensers but if the main body part of the tool is altered then the cover part 807 can be designed out reducing the overall cost. But it is often cheaper and simpler for a company to make the nozzle arrangement off line and then add it onto the current triggers.

Any of the previous configurations shown could also easily be fitted onto a trigger actuated dispensers or any other pumped or pressurized fluid. The pulsed versions that deliver a second or third fluid including air and the pulsed versions that electrostatically charge the discharge offer many advantages for trigger actuated dispensers and also spray pumps and aerosol actuators. The air would be drawn from outside of the triggers actuated dispensers and the fluid could be delivered from a separate part or chamber inside or outside of the main fluid container. Using the self cleaning versions would be ideal for some fluids that can potentially block such as where particulates are used and the versions that seal the orifice are ideal for fluids that can react to the air including food products.

In FIGS. 9a and 9b we see a version of FIG. 8 used in an aerosol can actuator 901. 9a shows the prodder 903 in the rest or sealed position and FIG. 9b shows the prodder 903 in the spraying position with a small circumferential gap around the prodder 903. It is much simpler than many other applications though because the actuator inlet 902 from the tubular chamber 912 where the aerosol valve is sealably fixed, is easily configured to enter tangentially around the prodder 903 downstream of the prodder seal 904 where it flows both upstream to the small downstream chamber 906 around the tip 909 of the prodder 903 and then to the final orifice 910 and simultaneously downstream to the plunger seal 904 which prevents the fluid from escaping upstream by sealing on the chamber wall 908. There is a spring 913 upstream of the prodder 903 that is fixed in place and retains the prodder 903 inside the chamber 914 and this exerts a downstream force on the prodder 903 so that it stays in the sealed position when at rest. The spring 913 is usually but not exclusively pretensioned to something like 1 bar upwards so that force has to be overcome before the prodder 903 moves away from the sealed position. With aerosols the flows tend to be very small and usually under 3 mls/sec so there is very little movement of the prodder 903 before the spring 913 also acts as a back stop preventing further upstream movement. This ensures that the prodder tip 909 never leaves the final orifice 910 and keeps the circumferential gap as small as required to optimize the droplet size. There are 1-3 circumferential threads around the prodder 903 so the fluid spins around the prodder 903 until it reaches the tiny annular chamber 906 when it spins around the prodder tip 909 and then exits the orifice 910 as an atomized spray. The design has to be optimized as described earlier to ensure that a substantially full cone is produced. The prodder 903 could have no grooves and instead a circumferential gap between it and the chamber and as the fluid enters tangentially from the inlet it will still spin around the prodder 903 and out into the tiny chamber 906. As in FIG. 8 the basic configuration won't produce a pulsed spray but will produce a continuous spray and to make the spray pulse it is necessary to make the prodder 903 resiliently deformable or to shape it such as in FIG. 3 so it can deform and reform like a spring or even to use a separate prodder spring. That way the prodder 903 stretches upstream before the prodder tip 909 moves to an unsealed position allowing the fluid to discharge which allows the prodder 903 to return to the sealed position driven by the main spring 913 reforming.

As has been shown a back stop can be added or the spring configured to many of these configurations so that the prodder can only move a set distance away from the sealing position. If there isn't one then the prodder tends to move further downstream creating a larger circumferential gap and this produces larger droplets. Also, the further the prodder moves the harder it is to configure everything so that a full cone with fine droplets is always produced. For applications where you want the nozzle arrangement to clean itself then you want a big movement to be possible yet this would create large droplets and a hollow cone so one option is to make the back stop so it can be moved or even taken away for the self cleaning cycle. There are many ways to achieve this including something as simple as a peg that can be temporarily removed or even a back stop that can be screwed or slid into position. Similarly the spring could be varied in tension instead.

The springs can often be configured to ensure that the prodder movement is minimal and an example of that is shown in FIG. 9b where the available movement for the prodder 903 before being stopped by the spring 913 being fully compressed is minimal.

Again, any of the previous configurations could be used inside an aerosol actuator and each has different advantages with different fluids. So the pulsed configurations that deliver a second or third fluid including air, the versions that can be self cleaning, the versions that charge the discharge electrostatically and even the static version in FIG. 1, can all be used.

The key to the configurations with the prodder in the orifice is that the prodder is able to move to find its own position in the orifice which is very dependant on the flow and also it preferentially but not exclusively needs to be substantially close to the sealing position in the normal operating position. As has been stated, everything has to be optimized for this to produce even a reasonable atomised spray let alone a high quality spray. Some of the versions are pulsed and can generate air as shown in previous figures and others produce a continuous discharge and cannot generate air, shock waves or an electrostatic charge. Many of them can be configured to act as a precompression valve where the nozzle arrangement won't open until a set pressure has been reached and many can also be configured to act as a self cleaning nozzle. Some of the versions also seal the orifice after use which can be very useful for some fluids.

One of the most advantageous properties of all of the configurations where the prodder is in the outlet hole and a small circumferential gap is used to create a spray or foam is where gas or air is added to the fluid. Normally you need to add a lot of gas to have any real effect on the spray but because the gaps are so tiny, far less gas is needed to create the same improvements. One of the main reasons for this is that the gas is often lost to the atmosphere as the fluid is converted into droplets at the orifice but with the fine circumferential gap it is more difficult for the air to escape so more is trapped inside the droplets and then breaks them up them as the air expands inside the droplets. So for generating finer droplets or for atomizing viscose fluids or for creating foams much less gas is needed. This gas can be added to the liquor itself in the canister or anywhere between the canister and the final orifice or in or downstream of the final orifice. Where the nozzle arrangements are fed from a pressurized source of fluid such as a pipe, it is often easy to add pressurized air from a secondary source such as a compressor and low ratios of air plus low pressures make the system much cheaper. Even ratios as little as 1/2 gas to liquor make a big difference whereas normally you need a minimum of 7/1 and usually much higher. The finer the circumferential gap the greater the effect of the gas and the finer the droplets produced.

Most of the configurations that create a pulse can also generate air that can be added to the first fluid to enhance the discharge either as an atomized spray or as a foam. We have only shown a few ways but for example the air could be directed into the outlet orifice itself and part of the way downstream of it and downstream of where the prodder would seal in the orifice. Or it could be directed at the spray as it leaves the orifice. Or it could be added to a chamber after the orifice such as where the spray is directed tangentially into a cylindrical chamber so it spins in the chamber and the air also usually spins and often counter tangentially. The fluid combination then exits through an end of the chamber. The air could also be added in such a way that it creates a shock wave that impacts on the spray further manipulating the droplets. Plus as previously stated, air or gas could also exist in the fluid and even low amounts cause finer droplets, better atomization and better foam.

Even simple pulse versions such as in FIG. 8 can be modified to add air to the discharge. Each time the prodder 810 moves upstream it compresses the air in the chamber upstream of the seal 812 and this could be directed through the prodder 810 to the prodder tip 813 where it would join the discharge. Or it could go to the small downstream chamber 814 and join the first fluid there. Or it could be directed to other places such as directly to the outlet orifice conical chamber 803. New air on the downstream stroke of the prodder 810 would be drawn from the outside through a one way valve in the chamber upstream of the seal 812. Something similar could be achieved by modifying the chamber upstream of the seal 304 in FIG. 3 or the chamber upstream of the seal 207 in FIG. 2. This would normally be fairly pointless because any gains won by the air would be offset by the consequent reduction in pressure of the first fluid but because the circumferential gap around the prodder is so fine, these low volumes of air make much more difference than the reduction of the pressure.

One of the problems with some of these configurations is moving the prodder far enough upstream to create a full circumferential gap around it because the liquor may only move it only as far as is necessary and it means that at low flows a full cone isn't produced. Adding gas or air in the fluid effectively increases the flow since the liquor flow rate is the same and this means that the prodder has to move further upstream and a full cone is produced at much lower liquor flows. It is generally better controlling the flow with a prethrottle somewhere upstream of the prodder and the prodder will move far enough upstream to maintain the flow set by the prethrottle. Preferably but not exclusively the prethrottle is positioned just upstream of the dose chamber holding the prodder and also preferentially the prethrottle directs the fluid into said chamber substantially tangentially causing the fluid to spin around the prodder. The prethrottle can also have a flow controller on or upstream of it so the fluid flow is maintained within set limits independent of the pressure of the fluid as this maintains a more constant circumferential gap around the prodder. Often there is a back stop on the prodder or the plunger to ensure that the ideal circumferential gap around the prodder is maintained.

The orifice has often been shown to have an outwardly tapered cone to produce a full cone spray. But this could also be shaped as an outwardly tapered oval cone to produce a fan shaped or oval spray. Or it could be shaped as a square tapered cone to produce square cones. The fluid would still be made to spin before the final orifice. It could even be an inwardly tapered cone.

Many applications mix 2 fluids to create a reaction between them and this system could easily do that. We have discussed fluid going into the second input and it could be any fluid including a liquor or gas or air and this could be drawn from any chamber or connecting tube and it wouldn't normally be pressurized although it could be. The second fluid could also be a mixture of a gas such as air and a liquor. The fluid or liquor could take any of the routes that the air took going to either the main downstream chamber, direct to the swirl input, or to the back of the swirl chamber, direct to a separate swirl chamber and orifice so two sprays join in the atmosphere, direct to an outlet tube or any other suitable alternative. Both the air and any fluid could also go to a tube that connects with the first fluid going through the downstream main chamber outlet into said tube. The second fluid could join the tube through a venturi hole to ensure that the fluids mix. In the examples shown, there is no one way valve in the outlet routes for the second fluid other than when it goes to the downstream main chamber but such a valve could be used if required.

We have shown that the nozzle arrangement can be used in many applications and that it can deliver a pulsed discharge of 2 fluids into the atmosphere or into a device of some kind. For example, it could be used in an engine to deliver fuel and air combined. It could be used to add an additive into a main fluid stream in a process. It could mix 2 different fluids together where one is stored in say an aerosol canister and the other is stored at ambient pressure in a container outside or on top of the aerosol container. Or similarly, it could mix 2 different fluids together where one is stored in say a dispenser pump container and the other is stored at ambient pressure in a different container outside or on top of the first container. It offers a method of mixing 2 fluids together in any required ratio even when they are at different pressures initially. The 2 fluids can be mixed together in any suitable way either inside or outside of the nozzle arrangement.

The pulsing element has often been shown as a one piece arrangement but it could be made in 2 or more parts and metal or plastic springs could be used instead of the resiliently deformable spring part of the pulsing element or instead of the resiliently deformable part of the prodder spring. Obviously, the simpler it is the cheaper it is to make and assemble.

Other designs of the pulsing element could be used and the important thing is to use a pulsing element that is able to move up and downstream so it can draw in a second fluid that is usually air and then pump that second fluid in such a way that it mixes or interacts with the first fluid.

The examples shown discharge two fluids substantially simultaneously but if one of those fluids is air then it can be advantageous to pump the air both when the pulsing elements moves downstream as shown and also or even instead, when it moves upstream so in effect when air is delivered with both strokes it delivers approximately twice the air with each cycle. The upstream stroke would only deliver air and not the first fluid but because the pulses are so fast that air could still be mixed with the first fluid both from the previous cycle and the next cycle. The air from the downstream stroke could be mixed with the first fluid either in the nozzle arrangement or outside of it as before. For example, if the device is set up to create foam then the air from the upstream stroke could help to clear away any residual foam reducing post foaming. This arrangement would usually be used with a liquor as the first fluid and air as the other fluid but it could be done with two different liquors and air as a third fluid.

There appears to be a big difference between some of the designs shown but they all use the prodder tip substantially in the orifice when producing a spray or foam. They rely on using a chamber with an inlet that is often tangential and controls the flow of fluid into it, an outlet from the chamber, a prodder and plunger in the chamber that may or may not be integral and have a sprung element between them and the prodder enters the outlet office from the chamber, the plunger is usually sprung loaded at the upstream end and seals off the chamber upstream, the prodder often pulses quickly and generates an almost continuous atomized spray which is sometimes converted into a foam. In some versions the plunger actually moves air upstream of it in the chamber but only some of the versions make use of that property with some pumping air to affect the discharge and others using liquor, gas, air or a combination of them. The fluid spins in the dose chamber around the prodder tip in the orifice to produce an atomized spray. Some start with the prodder clear of the orifice in the rest position and these are best for making them self cleaning whilst others start with the prodder sealed in the orifice but all versions use the prodder in the orifice when spraying. Even those that create a charge operate in the same way but make use of the appropriate materials to create the charge.

In all cases when pulsing a very fast pulsed spray is required so it appears to be a continuous spray. This is usually in excess of 20 pulses per second and certainly over 10. However, it has been shown that these arrangements can also produce a continuous spray and where the prodder stays in the orifice this can be configured to make an excellent atomized spray and this makes a very valuable set of products.

Whereas the invention has been described in relation to what is presently considered to be the most practical and preferred embodiments, it is to be understood that the invention is not limited to the disclosed arrangements but rather is intended to cover various modifications and equivalent constructions included within the spirit and scope of the invention.

1. A nozzle arrangement that produces an atomised spray or foam wherein the nozzle arrangement comprises a nozzle body with an inlet for a pressurized fluid into a chamber with an outlet orifice in the downstream wall and a mobile prodder with a substantially tapered conical or rounded tip inside of said chamber and at least part of the tip of the prodder protrudes inside the outlet orifice creating at least one circumferential gap between the prodder tip and the outlet orifice whereby the fluid spins around at least part of the prodder tip and out through the circumferential gap and produces an atomized spray or foam with a substantially full cone shape.

2. A nozzle arrangement according to claim 1 wherein the fluid spins around at least part of the prodder tip and one or more of the prodder tip size, shape or positions in the orifice or the orifice size, upstream or downstream shape or the size of the circumferential gap between the prodder tip and orifice or any combination of them have to be configured to create an atomized spray with a substantially full and even cone shape.

3. (canceled)

4. A nozzle arrangement according to claim 1 wherein there are two or more circumferential gaps around the prodder tip at or in the orifice, optionally wherein air flows through a hole into the small annular chamber between the two circumferential gaps.

5. (canceled)

6. A nozzle arrangement according to claim 1 wherein at least one circumferential gap is less than 10, 20, 100 or 500 microns, and/or wherein the circumferential gap varies in size according to the pressure or flow of the fluid.

7. A nozzle arrangement according to claim 1, wherein one or more of the orifice, prodder, chamber wall, the circumferential gap, the inlet into the chamber wall or any combination of them are shaped or configured so as to cause the fluid to rotate around at least part of the prodder tip, and/or wherein the fluid inlet into the chamber is substantially tangential to cause the fluid to spin around the chamber and at least part of the prodder tip.

8. (canceled)

9. A nozzle arrangement according to claim 1 wherein the prodder is spring loaded and slideably mounted and able to move inside the chamber and outlet orifice, and/or wherein the prodder is moved in the chamber in one direction by the action of the pressurized fluid and in the opposite direction by the action of a resiliently deformable element or spring.

10. (canceled)

11. A nozzle arrangement according to claim 1 where the resiliently deformable element or spring is pretensioned so the prodder cannot move from the rest position until the pressure of the fluid exceeds a set pressure.

12. A nozzle arrangement according to claim 1 wherein part of the prodder tip is inside the final orifice during at least most of the discharge cycle, and/or wherein part of the prodder tip is inside the final orifice during substantially all of the discharge cycle.

13. (canceled)

14. A nozzle arrangement according to claim 1 wherein the prodder seals the outlet orifice after the discharge cycle, or wherein the prodder is clear of the outlet orifice after the discharge cycle.

15. (canceled)

16. A nozzle arrangement according to claim 1 wherein the prodder can move to or through a position in the chamber that enables the nozzle arrangement to clear itself of any particulates in the orifice or around the prodder, optionally wherein the prodder can move to or through a position in the chamber where there is an enlarged gap between the prodder and chamber wall that enables any trapped particulates to be dislodged.

17. (canceled)

18. A nozzle arrangement according to claim 1 where there is a plunger in the chamber that is upstream of the prodder and connected to it and has an annular seal that forms a seal between the plunger and the chamber side wall, optionally wherein the plunger and prodder are connected by a resiliently deformable part such as a spring, optionally wherein the plunger and prodder are one component.

19-22. (canceled)

23. A nozzle arrangement according to claim 1 wherein the fluid enters the chamber downstream of the plunger seal, or wherein the fluid enters the chamber upstream of the plunger seal and past the plunger.

24. (canceled)

25. A nozzle arrangement according to claim 1 wherein the maximum upstream travel of the plunger is restricted, and/or wherein the maximum upstream travel of the plunger can be varied manually by the user, and/or wherein the maximum downstream travel of the prodder is restricted.

26-29. (canceled)

30. A nozzle arrangement according to claim 1 wherein there is a throttle upstream of the prodder that helps to regulate the flow control, and/or wherein there is a flow controller upstream of the prodder that controls the flow.

31. (canceled)

32. A nozzle arrangement according to claim 1 wherein the fluid is attached to the outlet of any pressurized source of fluid, and/or wherein the nozzle arrangement is attached to the outlet of any pressurized container including an aerosol canister.

33. A nozzle arrangement according to claim 1 wherein the fluid is pressurized by a dispenser pump that is manually actuated by a trigger or an actuator and the nozzle arrangement is attached to the outlet of the dispenser pump.

34. (canceled)

35. A nozzle arrangement according to claim 1 wherein the fluid is: a liquor; a liquor and a gas; or a liquor and gas which is air or CO2 or nitrogen, or butane or any other gas or a mixture of any of them.

36-37. (canceled)

38. A nozzle arrangement according to claim 1 wherein additional gas or air is added to the fluid before or as it is delivered to the nozzle arrangement or inside of it or as it exits the final orifice.

39. (canceled)

40. A nozzle arrangement according to claim 1 wherein at least part of the orifice tapers conically outwards downstream, and/or wherein at least part of the orifice tapers conically inwards downstream.

41-42. (canceled)

43. A nozzle arrangement according to claim 1 wherein there is an outlet chamber downstream of the outlet hole with one or more meshes in said chamber causing the spray discharge to foam.
